(19) United States
(12) Patent Application Publication
(10) Pub. No.: US 2018/0276627 A1
(43) Pub. Date: Sep. 27, 2018

(54) Detecting Complex Structured Transactions

(71) Applicant: Max Stanford Tomlinson, JR., Durham, NH (US)

(72) Inventor: Max Stanford Tomlinson, JR., Durham, NH (US)

(21) Appl. No.: 15/853,747

(22) Filed: Dec. 23, 2017

Related U.S. Application Data
(60) Provisional application No. 62/440,460, filed on Dec. 30, 2016.

(51) Int. Cl. G06Q 20/10; G06Q 20/40

(52) U.S. Cl. CPC G06Q 20/10; G06Q 20/4016

(57) ABSTRACT

This disclosure describes how to quickly determine if a money remittance might be part of a specific form of inappropriate financial structuring, herein identified as complex structured remittances. Complex structuring (a.k.a. many-to-many structuring or ‘smurfing’) occurs when, to avoid legal requirements, a large transaction is broken down into smaller transactions and is sent by many surrogate sending individuals to many surrogate receiving individuals. This disclosure shows how to detect that a transaction might be part of complex structuring as early as the 4^{th} transaction in a structured set of transactions. The disclosed invention reduces time from current overnight processing to real-time, where appropriate actions can be taken as early as at the point-of-sale and well before the transaction has been completed.

### RELATED APPLICATION

This application is based on and claims priority from U.S. Provisional Patent Application No. 62/440,460, filed Dec. 30, 2016, entitled DETECTING STRUCTURED TRANSACTIONS, by the same Inventor, Max Stanford Tomlinson Jr., the entire disclosure of which is hereby incorporated by reference.

### BACKGROUND

Money remittance businesses (MRBs) provide a service that helps millions of people support families and friends around the globe. The vast majority of all money remittances (a.k.a. wires or transfers or financial transactions) are for legitimate reasons, are made by law-abiding users and agents, and are done within the laws and regulations of the sending and receiving governments. The significance and necessity of this industry is recognized and supported by virtually all governments.

However, criminals and tax-evaders have used these same channels to send money illegally. Money remittance businesses are legally obligated to monitor, report, and/or block certain transactions. Because of the need to perform these obligations at the point-of-sale, the following major requirements need to be automated for all but the smallest companies:
identify customers,
screen customers against various lists,
request additional identification be collected when required,
report when customers pass thresholds,
identify and report unusual or suspicious transactions, and
stop inappropriate transactions at point-of-sale

Complying with these obligations can be daunting and expensive to implement. For cash-based MRBs, even the first obligation of identifying customers can be difficult. Many common practices and treatises cover much of the means, processes, and ways to satisfy most of these obligations. These practices are well known in the industry.

Government entities typically require certain actions be taken by MRBs and/or their agents when a sending or receiving customer is party to one or more transactions whose aggregated monetary amount exceeds certain thresholds. These actions include such things as collecting more or better identification, determining the source of the funds sent, and/or blocking the transaction from proceeding.

### Identifying Customers

To perform structuring analysis, individuals must be properly identified and different representations of the same individual must be resolved. The industry and regulatory bodies call this KYC or “Know Your Customer”. There are a plethora of articles, patents, and patent applications that discuss how to properly identify customers.

This identification (KYC) is imperative in most cases for structured transactions to be properly detected (the major exception being when detected structured transactions feed back into the proper identification of individuals). It is beyond the scope of this disclosure to discuss how these identification resolutions are made. However, that these identification resolutions have been done is assumed herein. Means to perform KYC are well known in the industry.

### Structuring

To avoid being asked for ID and/or having a transaction reported or blocked, customers and/or agents may “structure” a transaction. Structuring is defined by the United States Internal Revenue Service as follows:
conducting financial transactions in a specific pattern calculated to avoid the creation of certain records and reports required by BSA and 26 USC 6050I

There are many ways to structure transactions to avoid triggering reporting requirements. One of the simplest ways is for a sending customer to break a large transaction into multiple smaller transactions over time. Simple aggregation over longer periods of time than regulatory requirements dictate can catch these transactions and mark them for scrutiny. Alternatively, an individual might engage multiple surrogates to receive transactions which are then forwarded by the surrogates to the ultimate recipient. Aggregation on the sender can also easily identify this form of structuring. Most all companies in the industry currently perform sender aggregation.

A related method is for an individual to engage the services of multiple surrogates to send transactions to a single receiver. For this, aggregation on the recipient (rather than the sender) will catch these kinds of structuring. While not as commonly done, this is a recognized means to detect this method of structuring.

### Complex Structuring

However, if multiple surrogate senders and multiple surrogate receivers are utilized, the amounts sent and received can be kept much lower to avoid detection. This kind of structuring is called “Many-to-Many” or “smurfing”. This is diagrammatically depicted in FIGS. 4, 5, and 6. While manual and non-real-time methods are used in the industry to detect these kinds of transactions, all current methods are laborious (whether manual or computer implemented) and are typically done ‘overnight’ by computer (or longer when done manually). No one is currently doing this in real-time to ask for more information and/or block transactions of this kind at the point-of-sale.

Many legitimate situations can produce a “false positive” appearance of structuring. Some examples are: if the recipients are two unrelated businesses, one would expect them to receive remittances from multiple individuals; many grand-kids might send funds to the same older folks; the fees for sending multiple smaller amounts might be less than the fee for sending a single larger amount. A large set of related transactions is more likely to be structuring than a small set. A set of transactions with a small aggregate value is less likely to be structuring than a set with a large aggregate value. However, if mitigating reasons are not present, if the number of transactions is large, and/or the aggregate amount is large, the transactions are probably inappropriate. The costs for checking these mitigating circumstances can be significant, especially when human inspection is required.

In summary, there are two aspects of determining if a specific transaction is part of a larger set of many-to-many structured transactions. The first aspect is to determine if a set of transactions might be part of a many-to-many set of transactions. The second aspect is to determine if there are mitigating circumstances. This invention deals exclusively with the first aspect.

What Happens after a Set of Transactions is Determined to be Structured

After a set of transactions are presumed to be structured, the follow-on actions depend on regulatory directives and what a wire network decides to do. Typically, if the matter appears to be significant, the money remittance business files a suspicious activity report with one or more appropriate government agencies. The money remittance business may be required to put the funds in an escrow account and not complete the transaction. These outcomes fall beyond the scope of this disclosure and, other than notification to wire networks and/or the government agencies, are outside the scope of this disclosure.

### Big O Notation

In computer science, Big O notation is used to describe the worst-case performance of a computer implemented method. As used herein, O(N) means that, given N rows of information to be examined, the time it will take to examine the information will grow proportionally with the number of rows. O(N²) means that the execution time grows as the square of the number of rows. O(2^{N}) means that the execution time grows exponentially with the number of rows. O(1) means that, regardless of the number of rows being examined, the time remains constant. Big O notation can also be used to specify the space required (in memory or on disk), but that interpretation is not used in this disclosure.

### Unordered Hashes

In computer science, unordered hashes are well known structures that can be used to collect sets of information. Insertion, deletion, and lookup can be done with these structures in O(1) time.

There are a variety of ways to merge two unordered hashes. The simplest is to copy the smaller into the larger; this copy-merge takes O(N) time, where N is the number of elements in the smaller structure. Another way, called a fast-merge herein, is to create a super-structure that points to multiple unordered hashes; new elements can be added in O(1) by simply always choosing a particular set to add to (such as the ‘first’ set); lookup will be O(H), where H is the number of merged hashes, as each hash must be examined to see if it includes the lookup element. Finally, a combination of the two methods can be used if there are periods of slack times when the system is less busy, wherein fast-merging is done in real-time and the copy-merge is done during slack times; this combination, if possible because of slack times, has an effective O(1) merge time if H is relatively small.

For the invention disclosed herein, either merge method will work quite well, as the graph is sparsely connected, and N and H are quite small relative to the total number of individuals in the system.

### Speed Requirements

Prior art systems to detect complex structuring are typically run “overnight” or in the background. Because there have not been systems that can perform this search in real-time, government regulators have not pushed for this. Therefore, prior art systems have had no particular speed requirements, except to find these complex structuring within the time-frame of required filing (typically weeks to months).

To be practical for use in real-time situations, determining if a transaction is part of a many-to-many structuring must not take longer than the client and agent are willing to wait. In preferred embodiments, this duration should be less than one second—and highly preferable to be less than 1/10 second.

This required speed dramatically constrains the amount of searching that can occur in a computer-based system. To determine if a transaction might be part of a many-to-many structuring in systems with large databases and a high volume of transactions, an O(1) computational time is highly advantageous and virtually required.

### BRIEF DESCRIPTION OF THE INVENTION

This invention quickly determines if a set of money remittance transactions might be complex structuring. This detection is not currently well automated in the industry because the way to make said determinations in real-time has heretofore not been discovered. These determinations need to be done in real-time so that additional information can be requested and/or inappropriate transactions can be further examined and/or blocked prior to completion.

The disclosed invention reduces time from current O(N) or O(N²) to approximately O(1). This invention can determine if a new transaction is potentially structured on the first transaction that closes a “circle”, which can be as early as the 4^{th} transaction in a set of structured transactions.

Experimental evidence with a large data set shows that this invention performs such examinations within milliseconds of presenting a new transaction, on average. Prior art systems take much longer and are not “real-time”, making them unsuitable for alerting on and stopping inappropriate transactions at point-of-sale.

### DESCRIPTION OF THE INVENTION

To determine if a transaction might be part of a many-to-many structuring, this invention finds networks of sending and receiving groups that are self-dealing. Specifically, if two or more individuals are sending to the same two or more individuals, structuring may be going on.

To do this, the system receives transaction data from the wire network which is processing the remittance, saves the transaction data for examination, extracts all the receivers associated with each sender (or vice-versa), determines if any two or more senders have the same two or more receivers, and notifies the wire network when such overlaps are found.

The linkages for identifying individual persons can be based on names, IDs, addresses, phones, and other data elements in a set of transactions. This disclosure uses the word “individual”, and all these linkages are included in the meaning of individual.

The system uses “clusters” that contain a list of individuals in the cluster and a count of the “circles” in the cluster (the count can sometimes be simplified to a flag indicating that one or more circles exist, such as when the number of circles is not used in reducing false positives). These clusters are depicted as elements 791 and 792 in FIG. 7.

When first seen, the computer-based system assigns an individual to an empty “cluster” with a circle count of zero (or false, if a simple flag is being used). When a transaction is presented to the system, if the sender and receiver are in different clusters, it merges the two clusters into a single cluster and updates one or both of the individuals to point to the merged cluster. When merging two clusters, the number of circles in the new cluster is the sum of the number of circles in the two combined clusters (or the logical ‘or’ if a simple flag is being used). If, however, when a transaction is presented, if the sender and receiver are in the same cluster, and if they have not previously sent transactions between themselves, the count of circles in the cluster is incremented (or set true if a flag).

### Why it Works

If a cluster has no circles, then the transactions between the individuals form a tree. When merging two clusters without circles the two clusters share no individuals (because an individual is assigned to a single cluster and cannot be in both) and only the transaction under question is common between the two clusters—hence no circle is created. Using similar logic, if two clusters have circles, merging the two clusters with a single transaction cannot cause any new circles to be formed for the same reason, but, none of the previous circles disappear, so the merged cluster has exactly the same number of circles as the sum of the number of circles in the two unmerged clusters. This means that the only time a circle can be formed is when a transaction is added between two individuals already within the same cluster. In the preferred embodiment the circle count is only incremented if the two individuals have not sent transactions before. Arguments can be made that the number of times individuals have sent transactions is pertinent, and should also be accumulated separately or simply counted as additional circles, but this is not part of the current invention.

There are two key data structures (repeated many times). One is the set of individuals in a cluster (as diagrammatically depicted in FIG. 7 as elements 791 and 792). The other is the set of receivers already known by senders (as depicted by element 803 in FIG. 8). By using unordered hashes to implement these two data structures, this system can be implemented in near O(1) time. Only the merging of two clusters is not strictly O(1), but as discussed in the background section, there are methods that are very close to O(1) in normal operating situations.

While the discussion has been about clusters of individuals, equally valid are clusters of transactions and other equivalent data structures that represent the data such that O(1) insertion and lookup of potential transaction/individual circles are possible.

Experimental evidence indicates milli-second time-frames for single-transaction insertion and detection on large data sets are quite feasible with the disclosed invention.

### BRIEF DESCRIPTION OF THE DRAWINGS

FIG. 1 is a diagrammatic depiction of a One to Many set of transactions.

FIG. 2 is a depiction of a simple Many to One set of transactions.

FIG. 3 is a depiction of a set of transactions that are not one to many, many to one, or complex.

FIG. 4 is a diagrammatic depiction of the smallest set of transactions that might form complex structuring.

FIG. 5 is a diagrammatic depiction of a set of transactions that are much more likely to be complex structuring than those depicted in FIG. 4.

FIG. 6 is a depiction of a set of transactions similar to FIG. 3, expect the one additional transaction (element 606) means that it might be complex structuring.

FIG. 7 is a diagrammatic representation of key data structures, specifically clusters and individuals, and the relationships between them.

FIG. 8 is a diagrammatic representation of a key data structure, specifically the individual, and includes a sub-data structure, specifically the other individuals associated because of transactions they have in common with the individual. Note that an individual can be a sender, a receiver, or both.

### DESCRIPTION OF THE DRAWINGS

FIG. 1 is a depiction of a simple One to Many set of transactions 101, 102, and 103. Element 111 depicts a single sender. Elements 121, 122, and 123 depict three receivers. The transaction amounts can be summed (aggregated) to see if structuring is potentially being done. This kind of structuring is well known and excluded from the claims of this disclosure.

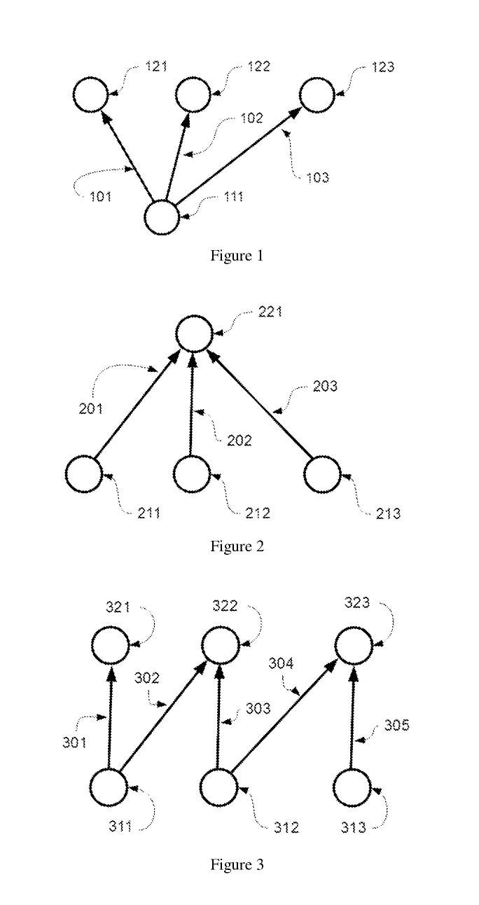

FIG. 2 is a depiction of a simple Many to One set of transactions 201, 202, and 203. Elements 211, 212, and 213 depict three sending individuals. Element 221 depicts a single receiving individual. The transaction amounts can be summed (aggregated) to see if structuring is potentially being done. This kind of structuring is well known and excluded from the claims of this disclosure.

FIG. 3 is a depiction of a set of transactions 301, 302, 303, 304, and 305, that are not structured as one to many, many to one, or complex (and are typically not considered structured unless there is other evidence). Elements 311, 312, and 313 depict three sending individuals. Elements 321, 322, and 323 depict receiving individuals. There are no ‘circles’ in the transactions—if one places a pencil on individual 311 and traces along the transactions without lifting the pencil or tracing a transaction twice, the pencil will not return to individual 311 along any path. This is not considered structuring (although one can easily imagine cases wherein this figure and either FIG. 1 or 2 are superimposed that could be structuring).

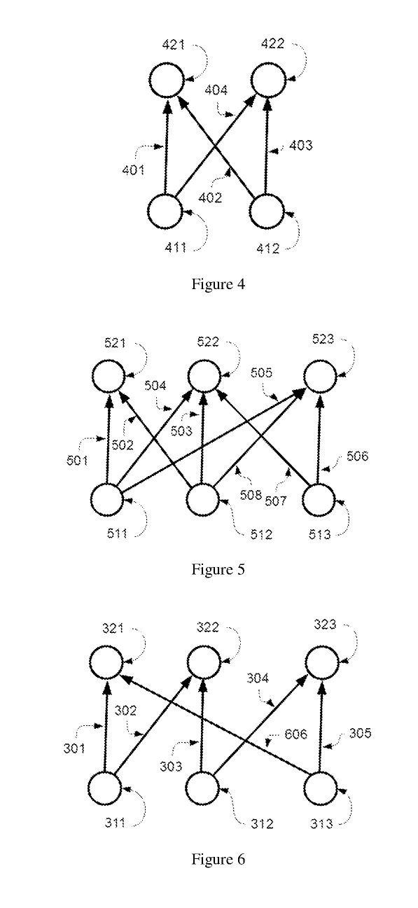

FIG. 4 is a depiction of a set of transactions (401, 402, 403, and 404) between senders (411 and 412) and receivers (421 and 422). Ignoring the directional arrows, the set of transactions form a circle (from 401 to 402 to 403 to 404 and back to 401). This figure depicts the smallest possible many to many structuring and is potentially inappropriate. If the receivers are parents and the senders are their children sending from different cities, this is probably not illegal structuring. If the people appear to be unrelated and are sending from the same location, structuring is a real possibility. The means to automatically decide if the circle (and other connected transactions) are actually structuring is outside the scope of this disclosure.

FIG. 5 is a larger version of FIG. 4 with multiple circles. It is a depiction of a set of transactions (501, 502, 503, 504, 505, 506, 507, and 508) between senders (511, 512, and 513) and receivers (521, 522, and 523). The set of transactions form multiple circles (ignoring the directional aspect of the transactions). Because there are multiple circles the probability of this being inappropriate structuring is higher than in FIG. 4. Again, the means to automatically decide if the transactions are actually structuring is outside the scope of this disclosure, but that there are more circles in the preferred embodiment can (and probably should be) used as a factor to present to that means.

FIG. 6 the same as FIG. 3, except there is one additional transaction, 606. All other elements, still with labels from FIG. 3, are the same as in FIG. 3. The new transaction 606 creates a circle. Because the number of transactions to create the circle is large, the probability of this circle being structuring is lower than in FIG. 4 (with its single circle). However, again, the means to automatically decide if the transactions are actually structured or if there are mitigating circumstance is outside the scope of this disclosure, but the number of transactions required to create a circle can (and should) be presented as a factor for that means to consider.

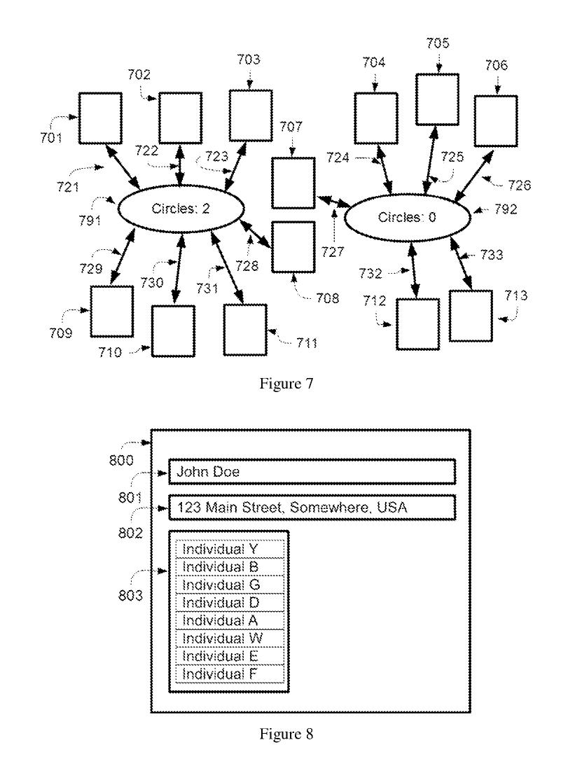

FIG. 7 gives an overview of the data structures used in a preferred embodiment of the invention. Elements 701 to 713 are representations of data structures holding information about individuals (and these data structures are further expanded in FIG. 8). Each individual's data structure has a connection (depicted as bidirectional lines 721 to 733) to one of the cluster data structures, 791 and 792. These connections can be implemented in a wide variety of manners, well known to those skilled in the art. For example, clusters are implemented in the preferred embodiment with unordered hashes of pointers to the connected individual's data structures, while the individuals' data structures each have a single pointer back to the associated cluster. Cluster 791 has the notation “Circles: 2” to indicate, that in addition to the unordered hash of pointers, it also holds a count of the number of detected circles. This count, as discussed previously, comes from incrementing the count as particular transactions are detected, and not from any other information depicted in this figure.

FIG. 8 is a diagram that shows partial details of a preferred embodiment of the information in one hypothetical individual's data structure 800. Element 801 represents the space used to hold the individual's name. Element 802 represents the space used to hold the individual's address. Element 803 represents an unordered hash holding information about which individuals have received transactions from the individual specified in element 800. In a full implementation, there would probably be additional information stored about an individual, including which transactions were sent or received by the individual, phone numbers, dates of birth, etc. The full scope of possible and pertinent data is well known by those in the industry and is beyond the scope of this disclosure.

There are many ways to implement the following claims, and they should be construed as to fall within these claims. For example, ‘individual’, ‘sender’, and ‘receiver’ may be human or legal entities, and ‘wire network’ may be a money service business, money remittance business, bank, store, individual, or similar. For clarity this detection system is discussed as separate from a wire network, but this detection system can and often will be implemented as part of a wire network's operations, and this is also claimed. Given this,

What I claim is:

1. A computer-implemented system for detecting potentially structured money remittances; where money remittance transactions flow outside said system from senders outside said system to receivers outside said system via one or more wire networks outside said system, and where government laws and regulations outside said system specify that additional actions outside of said system should be taken on certain inappropriate money remittance transactions and/or they should be reported to one or more government agencies outside said system; and where said system is comprised of:
a) receive means to receive a plurality of transaction data from said wire networks, each said transaction data including at least a sender and a receiver of a money remittance transaction;
b) storage means to retain said transaction data received by said receive means;
c) extraction means to collect extracted sets from said transaction data in said storage means, each extracted set being the set of receivers associated each said sender, said association occurring when a sender and a receiver have one or more transactions in common;
d) determination means to determine if the sender and receiver of a transaction are potential structurers, by examining said extracted sets, and determining which extracted sets have 2 or more receivers in common; and
e) notification means to notify said wire networks and/or said government agencies that the sender and/or receiver in a money remittance transaction is a potential structurer when so determine by said comparison means.

2. The system of claim 1, wherein said determination means is comprised of one or more clusters, said clusters maintaining a circle indicator that indicates if there are any circular connections between its constituent senders and receivers, and wherein said comparison means assigns each sender and receiver to a cluster and maintains said circular indicator in the following manner:
a) when a sender or receiver is first encountered, they are assigned to a new or empty cluster and the circle indicator is set to false;
b) when new transaction data is compared,
i. if the clusters associated with the sender and receiver of said transaction data are different, they are merged together into a single cluster, the associated senders and receivers of the two previously disparate clusters now being associated with the new merged cluster, and the circle indicator in the merged cluster being set to the logical ‘or’ of the circle indicators in the previously unmerged clusters, otherwise
ii. if the clusters associated with the sender and receiver of said transaction data are the same, the circle indicator in the associated cluster is set to true; and
c) when the circle indicator is true, the senders and receivers associated with the cluster are considered potential structurers.

3. The system of claim 1, wherein said determination means is comprised of one or more clusters, said clusters maintaining a circular count indicating how many circular connections exist between its constituent senders and receivers, and wherein said comparison means assigns each sender and receiver to a cluster and maintains the circular count in the following manner:
a) when a sender or receiver is first encountered, they are assigned to a new or empty cluster and the circular count is set to zero;
b) when new transaction data is compared,
i. if the clusters associated with the sender and receiver of said transaction data are different, they are merged together into a single cluster, the associated senders and receivers of the two previously disparate clusters now being associated with the new merged cluster, and the resulting circular count in the merged cluster being the sum of the circular counts in the two previously unmerged clusters, otherwise
ii. if the clusters associated with the sender and receiver of said transaction data are the same, the circular count in the associated cluster is incremented; and
c) when the circular count is greater than zero, the senders and receivers associated with the cluster are considered potential structurers.

4. The system of claim 1, wherein said system receives 3,600 transactions per hour or more and said comparison means makes its determination for each said transaction in less than 0.5 second on average.

5. The system of claim 1, wherein said system receives 10 transactions per second or more and said comparison means makes its determination for each said transaction in less than 0.5 second on average.

6. The system of claim 1, wherein said system has in its storage means 100,000 or more senders and said comparison means makes its determination on incoming transactions in less than 0.5 second on average.

7. A computer-implemented system for detecting potentially structured money remittances; where money remittance transactions flow outside said system from senders outside said system to receivers outside said system via one or more wire networks outside said system, and where government laws and regulations outside said system specify that additional actions outside of said system should be taken on certain inappropriate money remittance transactions and/or they should be reported to one or more government agencies outside said system; and where said system is comprised of:
a) receive means to receive a plurality of transaction data from said wire networks, each said transaction data including at least a sender and a receiver of a money remittance transaction;
b) storage means to retain said transaction data received by said receive means;
c) extraction means to collect extracted sets from said transaction data in said storage means, each extracted set being the set of senders associated each said receiver, said association occurring when a sender and a receiver have one or more transactions in common;
d) determination means to determine if the sender and receiver of a transaction are potential structurers, by examining said extracted sets, and determining which extracted sets have 2 or more senders in common; and
e) notification means to notify said wire networks and/or said government agencies that the sender and/or receiver in a money remittance transaction is a potential structurer when so determine by said comparison means.

8. The system of claim 7, wherein said determination means is comprised of one or more clusters, said clusters maintaining a circle indicator that indicates if there are any circular connections between its constituent senders and receivers, and wherein said comparison means assigns each sender and receiver to a cluster and maintains said circular indicator in the following manner:
f) when a sender or receiver is first encountered, they are assigned to a new or empty cluster and the circle indicator is set to false;
g) when new transaction data is compared,
iii. if the clusters associated with the sender and receiver of said transaction data are different, they are merged together into a single cluster, the associated senders and receivers of the two previously disparate clusters now being associated with the new merged cluster, and the circle indicator in the merged cluster being set to the logical ‘or’ of the circle indicators in the previously unmerged clusters, otherwise
iv. if the clusters associated with the sender and receiver of said transaction data are the same, the circle indicator in the associated cluster is set to true; and
h) when the circle indicator is true, the senders and receivers associated with the cluster are considered potential structurers.

9. The system of claim 7, wherein said determination means is comprised of one or more clusters, said clusters maintaining a circular count indicating how many circular connections exist between its constituent senders and receivers, and wherein said comparison means assigns each sender and receiver to a cluster and maintains the circular count in the following manner:
i) when a sender or receiver is first encountered, they are assigned to a new or empty cluster and the circular count is set to zero;
j) when new transaction data is compared,
v. if the clusters associated with the sender and receiver of said transaction data are different, they are merged together into a single cluster, the associated senders and receivers of the two previously disparate clusters now being associated with the new merged cluster, and the resulting circular count in the merged cluster being the sum of the circular counts in the two previously unmerged clusters, otherwise
vi. if the clusters associated with the sender and receiver of said transaction data are the same, the circular count in the associated cluster is incremented; and
k) when the circular count is greater than zero, the senders and receivers associated with the cluster are considered potential structurers.
